(19) United States
(12) Patent Application Publication
(10) Pub. No.: US 2015/0036999 A1
(43) Pub. Date: Feb. 5, 2015

(54) Viewer Attention Controlled Video Playback

(71) Applicant: Texas Instruments Incorporated, Dallas, TX (US)

(72) Inventors: Aziz Umit Batur, Dallas, TX (US); Osman Gokhan Sezer, Dallas, TX (US)

(73) Assignee: Texas Instruments Incorporated, Dallas, TX (US)

(21) Appl. No.: 13/954,928

(22) Filed: Jul. 30, 2013

(51) Int. Cl. H04N 5/91; G06F 3/01

(52) U.S. Cl. CPC H04N 5/91; G06F 3/013
USPC 386/230

(57) ABSTRACT

A method of viewer attention controlled video playback on a video display device is provided that includes displaying a video on a display included in the video display device, determining whether or not attention of a viewer watching the video is focused on the display, and halting the displaying of the video when the attention of the viewer is not focused on the display.

### BACKGROUND OF THE INVENTION

1. Field of the Invention

Embodiments of the present invention generally relate to viewer attention based control of video playback.

2. Description of the Related Art

When video is played on consumer devices with video displays (e.g., smart phones, televisions, laptop computers, tablet computers, desktop computers, gaming systems, etc.), the playback is typically continuous unless the viewer stops the playback using some type of physical control such as a pause button, an off button, etc. Thus, unless a viewer takes some physical action to stop the playback, the playback continues when the viewer's attention is diverted. The viewer may then need to restart the video playback at some earlier point in order to view the portion missed while the viewer's attention was diverted.

### SUMMARY

Embodiments of the present invention relate to methods, apparatus, and computer readable media for view attention controlled video playback. In one aspect, a method of viewer attention controlled video playback on a video display device is provided that includes displaying a video on a display included in the video display device, determining whether or not attention of a viewer watching the video is focused on the display, and halting the displaying of the video when the attention of the viewer is not focused on the display.

In one aspect, a video display device is provided that includes a display configured to display a video for a viewer, a video source configured to provide the video for playback on the display, means for determining whether or not attention of the viewer is focused on the display, and means for halting the display of the video when the attention of the viewer is not focused on the display.

In one aspect, a computer readable medium storing software instructions is provided. The software instructions, when executed by a processor, cause the performance of a method of viewer attention controlled video playback that includes displaying a video on a display, determining whether or not attention of a viewer watching the video is focused on the display, and halting the displaying of the video when the attention of the viewer is not focused on the display.

### BRIEF DESCRIPTION OF THE DRAWINGS

Particular embodiments in accordance with the invention will now be described, by way of example only, and with reference to the accompanying drawings:

FIGS. 1 and 2 are block diagrams of an example video display device; and

FIG. 3 is a flow diagram of a method.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

As previously mentioned, once video playback is initiated on a video display device, the playback is continuous unless the viewer takes some overt action to stop the playback. Thus, if a viewer's attention is temporarily diverted, the playback continues. Once the viewer's attention returns to the video playback, the viewer may need to replay the missed portion of the video. Current video display devices do not include functionality to stop video playback when the viewer's attention is diverted.

Embodiments of the invention provide for stopping video playback when a viewer's attention is diverted and resuming video playback when the viewer's attention returns to the video playback. The viewer's attention to the video playback may be determined by analyzing the gaze direction of the viewer. More specifically, in embodiments of the invention, a video display device includes a video capture component, e.g., a camera, that captures video of the viewer in real time as the viewer is watching a video playback on a display screen. The captured video of the viewer is processed in real-time to estimate the viewer's gaze direction. The estimated gaze direction is analyzed to determine whether or not the viewer is paying attention to the video playback. If the viewer's attention in determined to be diverted, the video playback is halted. While the video playback is halted, the video capture of the viewer and gaze direction analysis continues. When the viewer's attention is determined to have returned to the video playback, the video playback is resumed.

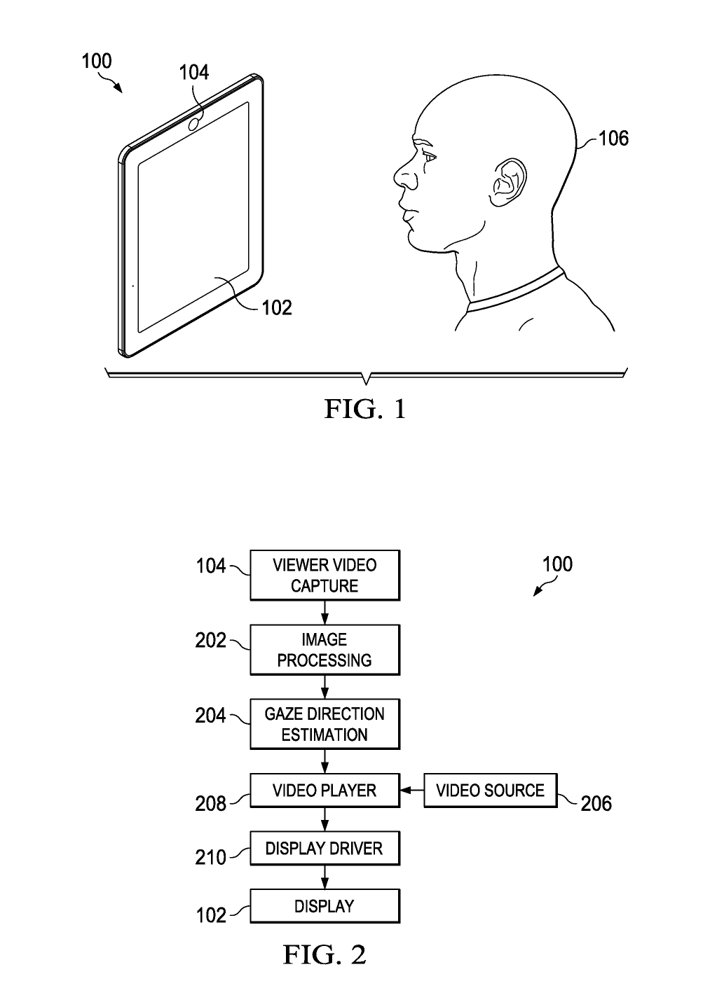

FIG. 1 shows a block diagram of an example video display device 100 being observed by a viewer 106. A viewer video capture component 104, e.g., a camera, is positioned in the video display device 100 to capture the viewer 106 in real time in a video sequence while video content is displayed on the display 102. As is explained in more detail herein, the viewer video sequence is analyzed to estimate the gaze direction of the viewer 106 as the viewer 106 watches video content shown on the display 102. The estimated gaze direction is then used to stop and start the video content depending on where the viewer's attention is focused to improve the viewing experience of the viewer 106.

For example, a student may be watching a pre-recorded video lecture. If the student's attention is diverted from the display, for example to work on a sample problem or to talk to someone, the video display device detects the lack of attention to the video lecture and stops the playback until the student's attention returns to the display. Thus, the student's viewing experience is improved as the student will not need to remember to pause the video playback while working on a sample problem and/or will not need to replay a portion of the pre-recorded lecture if his or her attention is temporarily diverted.

The video display device 100 of FIG. 1 includes a viewer video capture component 104 and a display 102 embodied in a single system. The single system may be, for example, a handheld display device specifically designed for use by a single user to view video content, a desktop computer, laptop computer, a cellular telephone, a handheld video gaming device, a tablet computing device, wearable 3D glasses, etc. that includes a video capture component that may be configured to capture a video sequence of a user. In other embodiments of the invention, the viewer video capture component and the display may be embodied separately. For example, a camera may be suitably positioned near or on top of a display screen to capture the video sequence of the viewer. In another example, one or more cameras may be placed in goggles or other headgear worn by the viewer to capture the viewer video sequence(s). Depending on the processing capability of the headgear, the video sequence(s) or gaze estimation data determined from the video sequences may be transmitted to a system controlling the video display.

FIG. 2 is a block diagram illustrating various components of an embodiment of the video display device 100 of FIG. 1. The video display device 100 includes the viewer video capture component 102, an image processing component 202, a gaze estimation component 204, a video source 206, a video player component 208, a display driver component 210, and the display 102.

The viewer video capture component 102 is positioned to capture images of a viewer with sufficient detail to permit the viewer's gaze direction to be determined. In some embodiments, the viewer video capture component 102 may be positioned to capture images that focus on the viewer's eyes. In some embodiments, the viewer video capture component 102 may be positioned to capture images that focus on the viewer's head. The viewer video capture component 102 may be, for example, a CMOS sensor, a CCD sensor, etc., that converts optical images to analog signals. These analog signals may then be converted to digital signals and provided to the image processing component 202. The remaining components of the system are described assuming that the video camera component 102 is a single imaging sensor. One of ordinary skill in the art will understand embodiments in which the viewer video capture component 102 includes other suitable imaging technology, such as, for example, a stereo camera system, a camera array, an infrared camera, a structure light camera, or a time of flight camera.

The image processing component 202 divides the incoming digital signal into frames of pixels and processes each frame to enhance the image in the frame. The processing performed may include one or more image enhancement techniques. For example, the image processing component 202 may perform one or more of black clamping, fault pixel correction, color filter array (CFA) interpolation, gamma correction, white balancing, color space conversion, edge enhancement, detection of the quality of the lens focus for auto focusing, and detection of average scene brightness for auto exposure adjustment. The processed frames are provided to the gaze estimation component 204. In some embodiments, the viewer video capture component 102 and the image processing component 202 may be a digital video camera.

The gaze direction estimation component 204 includes functionality to analyze the frames of the viewer video sequence in real-time, i.e., as a video is displayed on the display 102, and to estimate the gaze direction of the viewer, also referred to as point of regard (PoR) or point of gaze (POG), from the viewer video sequence. Any suitable technique with sufficient accuracy may be used to implement the gaze direction estimation. Some suitable techniques are described in D. W. Hansen and Q. Ji, “In the Eye of the Beholder: A Survey of Models for Eyes and Gaze”, IEEE Transactions on Pattern Analysis and Machine Intelligence, Vol. 32, No. 3, 2010 (“Hansen” herein). The gaze direction estimates, i.e., indications of where the viewer's gaze is directed, are provided to the video player component 208.

The video source 206 provides a video sequence to the video player component 208 for display on the display 102 via the display driver component 210. The video source 206 may be, for example, a pre-recorded video sequence, a graphics system that generates a video sequence in real-time, a camera system that captures a video sequence in real-time, a computer-generated hybrid synthesis of 2D images and 3D depth information, etc.

The video player component 208 includes functionality to control the presentation of the video sequence from the video source 206 on the display 102. The functionality may include a user interface that allows a user to control the presentation, e.g., to start and stop the playback of the video sequence, to fast forward or rewind the video sequence, etc. Further, the video player component 208 includes functionality to activate the viewer video capture component 102, the image processing component 202, and the gaze direction estimation component 204 to initiate real time capture and analysis of the viewer video sequence when the viewer 106 initiates the display of a video sequence on the video display device 100 and to deactivate the components to terminate the capture and analysis of the viewer video sequence when the display of the video sequence is terminated.

The video player component 208 also includes functionality to use the estimates of gaze direction from the gaze direction estimation component 204 to determine whether or not the attention of the viewer 106 is focused on the display 102 or has been diverted. If the attention of the viewer 106 is determined to be diverted, the video player component 208 stops the display of the video sequence until further gaze direction estimates indicate that the viewer's attention is again focused on the display 102 at which time display of the video sequence is resumed.

The display driver component 210 includes functionality to receive frames of the video sequence from the video player component 210 and cause the frames to be displayed on the display 102.

The video display device 100 may operate as follows in some embodiments. The viewer 106 initiates the playback of a video sequence from the video source 206 via a user interface of the video player component 208. The video player component 208 then activates the viewer video capture device 104, the image processing component 202, and the gaze direction estimation component 204 for real time capture and analysis of a video sequence of the viewer as the viewer is watching the video playback on the display 102. The capture and analysis of the viewer video sequence continues until the video playback is terminated, e.g., by the viewer terminating the playback via the user interface of the video player component 208.

The gaze direction estimation component 204 analyzes the viewer video sequence in real time to determine estimates of the viewer's gaze direction and provides these estimates to the video player component 208. The video player component 208 uses the gaze direction estimates to determine whether or not the viewer's attention is focused on the display 102. If the viewer's attention is determined to not be focused on the display 102, the video player component 208 halts the video playback (if active) until the gaze direction estimates indicate that the viewer's attention has returned to the display 102. Once the viewer's focus is determined to be on the display 102, the video player component 208 resumes the video playback.

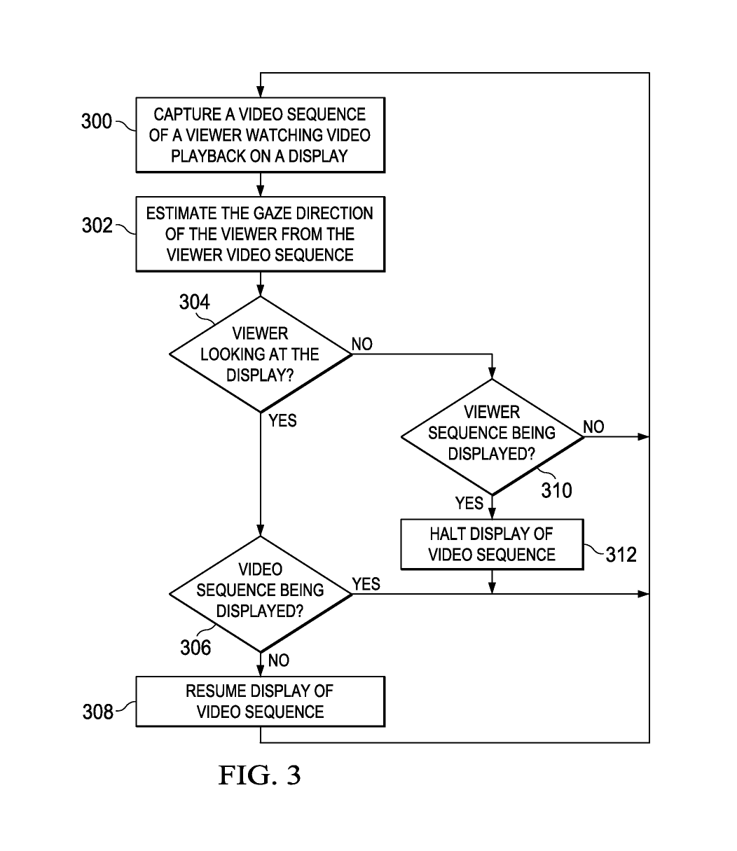

FIG. 3 is a flow diagram of a method for viewer attention controlled video playback. A video sequence of a viewer is captured 300 in real time as the viewer is watching playback of a video sequence on a display. In some embodiments, the video sequence may be captured by one or more cameras focused on the viewer's eyes. In some embodiments, the video sequence may be captured by one or more cameras focused on the viewer's head. The video sequence shown on the display may be, for example, a pre-recorded video sequence, a video sequence generated in real-time by a computer graphics system (such as in a 3D computer game), a video sequence captured in real time by one or more cameras, etc.

The viewer's gaze direction is estimated 302 from the viewer video sequence in real-time. Any suitable technique for gaze direction estimation with sufficient accuracy may be used. For example, the gaze direction estimation may be accomplished by a video processing algorithm that detects the viewer's eyes in real-time, tracks their movement, and estimates the gaze direction. As was previously mentioned, some suitable techniques are described in Hansen.

A determination 304 is then made as to whether or not the viewer is looking at the display. This determination is based on the gaze direction estimations derived from the viewer video sequence. If the viewer is looking 304 at the display, i.e., the viewer's attention is focused on the display, and the video playback is active 306, then capturing and processing of the viewer video sequence and video play back continues. If the viewer is looking 304 at the display and the video playback is not active 306, then the video playback is resumed 308 and capturing and processing of the viewer video sequence and video play back continues.

If the viewer is not looking 304 at the display and the video playback is not active 310, then capturing and processing of the viewer video sequence continues without video playback. If the viewer is not looking 304 at the display and the video playback is active 310, then the video playback is halted 312 and capturing and processing of the viewer video sequence continues without video playback.

### Other Embodiments

While the invention has been described with respect to a limited number of embodiments, those skilled in the art, having benefit of this disclosure, will appreciate that other embodiments can be devised which do not depart from the scope of the invention as disclosed herein.

For example, in some embodiments, knowledge of the content of the video playback may be used to refine the decision as to whether or not to halt video playback when a viewer's attention is diverted from the display. For example, if the video playback is of a horror movie or a movie with violent scenes, the viewer may not want to have the video playback automatically halted because the viewer deliberately chooses not to watch certain scenes. The analysis of the viewer video sequence may include identifying gestures or viewer facial expressions or other indicators of a viewer's deliberate avoidance of disturbing or frightening images in the video playback that may be considered along with the gaze direction estimation in deciding whether or not to halt video playback when the viewer's attention is not focused on the display.

In another example, while embodiments have been described herein in which a single viewer is assumed, one of ordinary skill in the art will understand embodiments in which multiple viewers are watching video playback on a video display device. In some such embodiments, control may be given to a single viewer of the multiple viewers, e.g., the closest viewer. In some such embodiments, the gaze directions of each of the multiple viewers may be estimated and the attention focus of each viewer determined. When a majority of the viewers are not focused on the display, the video playback may be halted until the focus of a majority returns to the display. In some such embodiments, the gaze directions of each of the multiple viewers may be estimated and the attention focus of each viewer determined. When all of the viewers are not focused on the display, the video playback may be halted until the focus of all returns to the display.

Embodiments of the methods and systems described herein may be implemented in hardware, software, firmware, or any combination thereof. If completely or partially implemented in software, the software may be executed in one or more processors, such as a microprocessor, application specific integrated circuit (ASIC), field programmable gate array (FPGA), or digital signal processor (DSP). The software instructions may be initially stored in a computer-readable medium and loaded and executed in the processor or processors. In some cases, the software instructions may also be sold in a computer program product, which includes the computer-readable medium and packaging materials for the computer-readable medium. In some cases, the software instructions may be distributed via removable computer readable media, via a transmission path from computer readable media on another digital system, etc. Examples of computer-readable media include non-writable storage media such as read-only memory devices, writable storage media such as disks, flash memory, memory, or a combination thereof.

Although method steps may be presented and described herein in a sequential fashion, one or more of the steps shown in the figures and described herein may be performed concurrently, may be combined, and/or may be performed in a different order than the order shown in the figures and/or described herein. Accordingly, embodiments should not be considered limited to the specific ordering of steps shown in the figures and/or described herein.

It is therefore contemplated that the appended claims will cover any such modifications of the embodiments as fall within the true scope of the invention.

What is claimed is:

1. A method of viewer attention controlled video playback on a video display device, the method comprising:
displaying a video on a display comprised in the video display device;
determining whether or not attention of a viewer watching the video is focused on the display; and
halting the displaying of the video when the attention of the viewer is not focused on the display.

2. The method of claim 1, further comprising:
capturing a video sequence of the viewer as the viewer watches the video; and
estimating gaze direction of the viewer from the video sequence,
wherein determining whether or not attention of the viewer is focused on the display is based on the estimated gaze direction.

3. The method of claim 1, further comprising resuming the displaying of the video when the attention of the viewer is focused on the display and the displaying is halted.

4. A video display device comprising:
a display configured to display a video for a viewer;
a video source configured to provide the video for playback on the display;
means for determining whether or not attention of the viewer is focused on the display; and
means for halting the display of the video when the attention of the viewer is not focused on the display.

5. The video display device of claim 4, further comprising:
means for capturing a video sequence of the viewer as the viewer watches the video; and
means for estimating gaze direction of the viewer from the video sequence,
wherein the means for determining whether or not attention of the viewer is focused on the display bases the determining on the estimated gaze direction.

6. The video display device of claim 4, further comprising:
means for resuming the display of the video when the attention of the viewer is focused on the display and the display of the video is halted.

7. A computer readable medium storing software instructions that, when executed by a processor, cause the performance of a method of viewer attention controlled video playback, the method comprising:
displaying a video on a display;
determining whether or not attention of a viewer watching the video is focused on the display; and
halting the displaying of the video when the attention of the viewer is not focused on the display.

8. The computer readable medium of claim 7, the method further comprising:
capturing a video sequence of the viewer as the viewer watches the video; and
estimating gaze direction of the viewer from the video sequence,
wherein determining whether or not attention of the viewer is focused on the display is based on the estimated gaze direction.

9. The computer readable medium of claim 7, the method further comprising resuming the displaying of the video when the attention of the viewer is focused on the display and the displaying is halted.
